(19) United States
(12) Patent Application Publication
(10) Pub. No.: US 2016/0104958 A1
(43) Pub. Date: Apr. 14, 2016

(54) Terminal Connection Structure

(71) Applicant: Yazaki Corporation, Tokyo (JP)

(72) Inventor: Yuji Hakii, Susono-shi (JP)

(73) Assignee: Yazaki Corporation, Tokyo (JP)

(21) Appl. No.: 14/974,471

(22) Filed: Dec. 18, 2015

Related U.S. Application Data
(63) Continuation of application No. PCT/JP2014/067248, filed on Jun. 27, 2014.

(30) Foreign Application Priority Data
Jul. 19, 2013 (JP) 2013-150886

(51) Int. Cl. H01R 13/11; H01R 9/05

(52) U.S. Cl. CPC H01R 13/112; H01R 9/05

(57) ABSTRACT

A terminal connection structure connects a male terminal to a female terminal. The male terminal is provided with a male terminal body which is formed in a flat plate shape and a tab terminal portion which extends from a tip end of the male terminal body toward a direction of connection to the female terminal on the same plane as the male terminal body. The female terminal is provided with a female terminal body which is formed in a flat plate shape and a pair of contact terminal portions which extends from a tip end of the female terminal body toward a direction of connection to the male terminal on the same plane as the female terminal body.

### CROSS REFERENCE TO RELATED APPLICATIONS

This application claims priority from Japanese Patent Application No. 2013-150886 filed on Jul. 19, 2013, the entire contents of which are incorporated herein by reference.

### TECHNICAL FIELD

The present invention relates to a terminal connection structure.

### BACKGROUND ART

In general, in a wire harness connected to an electronic device such as a backup camera or a car navigation device in a vehicle such as a car, a connector provided with a box-shaped terminal, a cantilever spring terminal, or the like is used. The box-shaped terminal is robust to vibration but is inappropriate for high-speed digital transmission at a rate of several Gbps. In addition, the cantilever spring terminal is appropriate for high-speed digital transmission, but the occurrence of instantaneous interruption or contact failure due to vibration is a concern.

Here, a terminal connection structure which is constituted by a tuning fork type female terminal that is more robust to vibration than the cantilever spring terminal and is more appropriate for high-speed digital transmission than the box-shaped terminal, and a male terminal connected to the female terminal is examined (refer to Patent Literatures 1 and 2). The tuning fork type female terminal has a tuning fork shape by forming a pair of cantilever spring-shaped contact terminal portions which face each other in the female terminal body having a flat surface shape through press-forming. In the tuning fork type female terminal, a tab terminal portion of the male terminal, in which the plate-shaped tab terminal portion is formed in the male terminal body having a flat plate shape, is inserted between the contact terminal portions of the tuning fork type female terminal, such that the tab terminal portion is pinched between the contact terminal portions and is electrically connected thereto.

### PRIOR ART LITERATURE

### Patent Literature

[Patent Literature 1] JPA Publication No. 2000-40563

[Patent Literature 2] Japanese Patent No. 3414402

### SUMMARY OF INVENTION

### Technical Problem

However, the terminal connection structure constituted by the tuning fork type female terminal and the male terminal that is fitted and connected thereto has the following problems.

(1) At a point where the tuning fork type female terminal and the male terminal come into contact with each other, the tab terminal portion of the male terminal is disposed perpendicular to a plane on which the female terminal body is formed. When the female terminal body which forms the main flat surface of the female terminal and the tab terminal portion which forms the main flat surface of the male terminal are rotated relative to each other by about 90 degrees, there may be a case where good electrical characteristics are not obtained during high-speed digital transmission.

(2) At a point where the tuning fork type female terminal and the male terminal come into contact with each other, there is concern that when the width, thickness, and the like of the contact terminal portions of the female terminal and the tab terminal portion of the male terminal vary, impedance characteristics and S-parameters that are dependent thereon may vary. Therefore, there may be a case where good electrical characteristics are not obtained during high-speed digital transmission.

The present invention has been made taking the foregoing circumstances into consideration, and an object thereof is to provide a terminal connection structure capable of coping with high-speed digital transmission and obtaining good electrical characteristics.

### Solution to Problem

In order to accomplish the object, the terminal connection structure according to the present invention has the following features (1) to (4).
(1) The terminal connection structure,

wherein the terminal connection structure connects a male terminal to a female terminal,

wherein the male terminal comprises:

a male terminal body which is formed in a flat plate shape; and

a tab terminal portion which extends from a tip end of the male terminal body toward a direction of connection to the female terminal on the same plane as the male terminal body,

wherein the female terminal comprises:

a female terminal body which is formed in a flat plate shape; and

a pair of contact terminal portions which extends from a tip end of the female terminal body toward a direction of connection to the male terminal on the same plane as the female terminal body, and

wherein the tab terminal portion of the male terminal is positioned between the pair of contact terminal portions of the female terminal on the same plane as the plane on which the contact terminal portions extend, and the tab terminal portion abuts the pair of contact terminal portions,

wherein widths of the male terminal body and the female terminal are even in a contact point where the male terminal and the female terminal are contact with each other.
(3) The terminal connection structure according to (1),

wherein contact portions which protrude in directions to face each other are formed in the contact terminal portions.
(4) The terminal connection structure according to any one of from (1) to (3),

wherein engagement protrusions which abut the contact terminal portions are formed in the male terminal body.
(5) The terminal connection structure according to (4) or (5),

wherein the engagement protrusions comprises:

guide surface portions which displace tip end portions of the contact terminal portions toward the tab terminal portion side.

In the terminal connection structure having the configuration of (1), since the male terminal and the female terminal are disposed on the same plane and are fitted to each other to come into contact with each other, the characteristic impedance becomes substantially constant. As a result, ideal electrical characteristics with substantially no reflections are obtained in a contact point of the male terminal and the female terminal.

In addition, while current which transports a signal flows through a path directed toward the center of the male terminal from the ends of a tuning fork type female terminal in a terminal connection structure having the tuning fork type female terminal of the related art, in the terminal connection structure of the present invention, current which transports a signal flows through a straight path connecting the male terminal and the female terminal. As a result, this contributes to the suppression of the deterioration of the electrical characteristics.

In the terminal connection structure of the present invention, the male terminal and the female terminal can be regarded as being the same as differential stripline transmission lines. In the terminal connection structure of the present invention, a change in physical shape at the point where the male terminal and the female terminal are fitted to each other is suppressed. As a result of a small change in physical shape, excellent electrical characteristics are exhibited.

In the terminal connection structure having the configuration of (2), by fitting the male terminal and the female terminal to each other, the contact portions formed in the contact terminal portions of the female terminal come into contact with the tab terminal portion of the male terminal, and thus a good conduction state can be obtained.

In the terminal connection structure having the configuration of (3), by fitting the male terminal and the female terminal to each other, the contact terminal portions of the female terminal abut the engagement protrusions of the male terminal. Accordingly, a shape advantageous to the characteristics of a high-frequency wave that flows through the surface or edge of a transmission line is achieved.

In the terminal connection structure having the configuration of (4), by fitting the male terminal and the female terminal to each other, the tip ends of the contact terminal portions of the female terminal are displaced toward the tab terminal portion side by the guide surface portions of the engagement protrusions. Accordingly, the contact terminal portions are pressed against and come into close contact with the tab terminal portion, and thus conduction is reliably achieved.

### Advantageous Effects of Invention

According to the present invention, a terminal connection structure which can cope with high-speed digital transmission and can obtain good electrical characteristics can be provided.

Hereinabove, the present invention has been briefly described. Furthermore, by reading through embodiments for embodying the invention described hereinafter (hereinafter, referred to as “embodiments”) with reference to the accompanying drawings, the details of the present invention will become more apparent.

### BRIEF DESCRIPTION OF DRAWINGS

FIG. 1 is a perspective view illustrating a terminal connection structure according to an embodiment before fitting.

FIG. 2A and FIG. 2B are views illustrating the terminal connection structure according to the embodiment, in which FIG. 2A is a perspective view in the middle of fitting, and FIG. 2B is a perspective view during fitting.

FIG. 3A and FIG. 3B are graphs showing the waveforms of harmonics.

FIG. 4 is a schematic cross-sectional view illustrating the structure of a general coaxial cable.

FIG. 5 is a schematic cross-sectional view illustrating the structure of a general printed wiring board.

FIG. 6 is a perspective view of a connection point of the coaxial cable and the printed wiring board.

FIG. 7A and FIG. 7B are views showing the impedance of a port, in which FIG. 7A is a schematic view showing the impedance of the coaxial cable, and FIG. 7B is a schematic view showing the impedance of a microstrip line.

FIG. 8A and FIG. 8B show TDR waveforms that represent the impedance characteristics at a connection point in a case where the coaxial cable and the microstrip line are connected to each other, in which FIG. 8A shows the impedance characteristics viewed from the coaxial cable, and FIG. 8B shows the impedance characteristics viewed from the microstrip line.

FIG. 9 is a schematic configuration view showing a postulated model of a transmission line.

FIG. 10A to FIG. 10E are views showing verification results of impedance during fitting of a male terminal and a tuning fork type female terminal, and FIG. 10A to FIG. 10E are views of the fitting state of the male terminal and the female terminal and the impedance in a state where the arrangement, posture, and the like of the terminal connection structure are changed.

FIG. 11 is a perspective view showing the model dimensions of the terminal connection structure constituted by the male terminal and the tuning fork type female terminal.

FIG. 12 is a schematic cross-sectional view illustrating a differential stripline.

FIG. 13 is a view showing the fitting state of the terminal connection structure according to the embodiment and the impedance characteristics.

### DESCRIPTION OF EMBODIMENTS

Hereinafter, examples of embodiments according to the present invention will be described with reference to the drawings.

### [Structures of Female Terminal and Male Terminal]

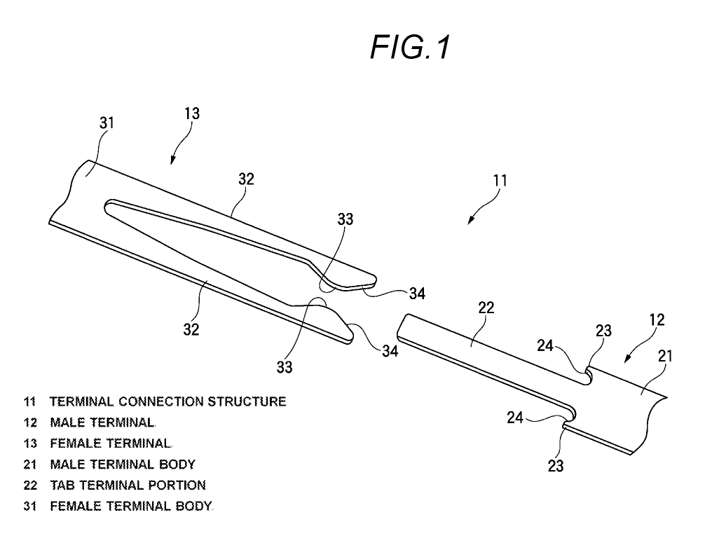

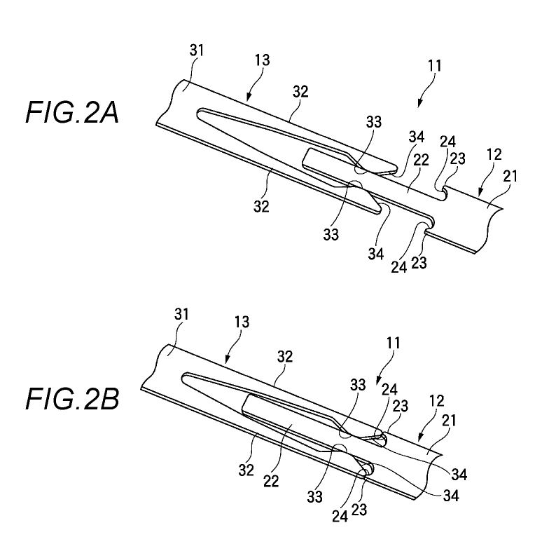

First, a terminal connection structure or an embodiment according to the present invention will be described. FIG. 1 is a perspective view illustrating the terminal connection structure according to the embodiment before fitting. FIG. 2A and FIG. 2B are views illustrating the terminal connection structure according to the embodiment, in which FIG. 2A is a perspective view in the middle of fitting, and FIG. 2B is a perspective view during fitting.

As illustrated in FIG. 1, a terminal connection structure 11 according to the embodiment is constituted by a male terminal 12 and a female terminal 13. The male terminal 12 and the female terminal 13 are formed by performing press-forming on a conductive metal plate made of copper, a copper alloy, or the like. The surfaces of the male terminal 12 and the female terminal 13 which are formed may also be plated with tin, gold, nickel, or the like. In addition, the male terminal 12 and the female terminal 13 of the present invention are not limited to the absence or presence of a surface treatment such as plating, and are not limited to the type surface treatment in a case where the surface treatment is performed. The rear end portions of the male terminal 12 and the female terminal 13 are provided with connection portions (not illustrated). The wire of a wire harness is connected to the connection portion. The male terminal 12 and the female terminal 13 are accommodated in housings forming connectors. By fitting the connectors to each other, the male terminal 12 and the female terminal 13 are electrically connected to each other.

The male terminal 12 includes a male terminal body 21 and a tab terminal portion 22. As illustrated in FIG. 1, the male terminal body 21 is formed in a fiat plate shape. The tab terminal portion 22 is formed in the tip end portion of the male terminal body 21 and extends from the center portion of the tip end of the male terminal body 21. The tab terminal portion 22 has a smaller width dimension than the male terminal body 21. The tab terminal portion 22 is formed on the same plane as that of the male terminal body 21. In the male terminal 12, engagement protrusions 23 are formed on both sides of the tab terminal portion 22 in the tip end of the male terminal body 21. The engagement protrusions 23 are provided with guide surface portions 24 which are formed to be gradually inclined toward the center side in the width direction as it moves toward the rear end of the male terminal 12.

The female terminal 13 includes a female terminal body 31 and a pair of contact terminal portions 32. The female terminal body 31 is formed in a flat plate shape, and the pair of contact terminal portions 32 are formed integrally with the tap end side of the female terminal body 31. Each of the contact terminal portions 32 is formed on the same plane as that of the female terminal body 31. The contact terminal portions 32 extend toward the tip end from both ends of the tip end of the female terminal body 31. The width dimensions of the contact terminal portions 32 are gradually reduced toward the tip end from the female terminal body 31. The contact terminal portions 32 are separated from each other while being directed toward the tip end. The contact terminal portions 32 have contact portions 33 which are formed in the vicinity of the tip end thereof. The contact portions 33 protrude toward the inside where the contact portions 33 oppose each other. The interval between the contact portions 33 which are respectively provided in the contact terminal portions 32 is slightly smaller than the width dimension of the tab terminal portion 22 of the male terminal 12. The contact portions 33 have tapered portions 34 which are formed on the tip end sides of the contact terminal portions 32. The tapered portions 34 are inclined in a direction approaching each other while being directed toward the rear endside of the contact terminal portions 32. The tip end portion of each of the contact terminal portions 32 is formed in an arc shape.

Next, a structure in which the male terminal 12 and the female terminal 13 are fitted and electrically connected to each other will be described.

In a state in which the tab terminal portion 22 of the male terminal 12 is directed toward the contact terminal portion 32 side of the female terminal 13, the male terminal 12 and the female terminal 13 are allowed to approach each other. The tip end portion of the tab terminal portion 22 of the male terminal 12 then comes into contact with the tapered portions 34 of the female terminal 13, and the tab terminal portion 22 is guided between the pair of contact terminal portions 32.

When the male terminal 12 and the female terminal 13 are allowed to further approach each other, as illustrated in FIG. 2A, the tab terminal portion 22 of the male terminal 12 inserted between the contact terminal portions 32 of the female terminal 13. Accordingly, the side surfaces of the tab terminal portion 22 of the male terminal 12 come into contact with the contact portions 33 of the contact terminal portions 32.

When the male terminal 12 and the female terminal 13 are allowed to further approach each other, as illustrated in FIG. 2B, the tab terminal portion 22 of the male terminal 12 is further inserted between the contact terminal portions 32 of the female terminal 13. Accordingly, the tip end portion of the tab terminal portion 22 of the male terminal 12 comes into contact with the side surfaces of the contact terminal portions 32 of the female terminal 13. In addition, the tip end portions of the contact terminal portions 32 of the female terminal 13 abut the engagement protrusions 23 formed on the tip end side of the male terminal body 21 of the male terminal 12. Accordingly, the tip end portions of the contact terminal portions 32 of the female terminal 13 are displaced toward the center side in the width direction by the guide surface portions 24 of the engagement protrusions 23 such that the contact portions 33 are pressed against and come into close contact with the side surfaces of the tab terminal portion 22.

In addition, by fitting and connecting the male terminal 12 and the female terminal 13 to each other as described above, the male terminal 12 and the female terminal 13 come into contact with each other at plurality of points on the same plane and are electrically connected to each other.

### [Actions and Effects of the Present Invention]

Hereinafter, the actions and effects of the present invention will be described on the basis of the analysis results of an electromagnetic analysis simulation.

<Items Analyzed by Electromagnetic Analysis Simulation>

First, items as an object to be analyzed by the electromagnetic analysis simulation will be described. In a connector used for high-speed digital transmission at a rate of several Gbps, stability in electrical characteristics, such as impedance matching or a reduction in reflection loss is strongly required. For example, when impedance is different from a target value 100 [Ω] by 25 [Ω], the reflecton loss becomes about 19 [dB], and an input signal is transmitted with a loss of about 10%. When such a case occurs at a plurality of points, the loss is further increased. Therefore, attenuation that occurs at a connection portion such as a connector has to be reduced as much as possible.

In addition, in a high-speed digital transmission line, the dielectric loss (ohmic loss unique to a material at a high frequency) in a cable section becomes dominant, and most of the loss in a transmission system is caused by the dielectric loss. That is, in a case of lengthening the high-speed digital transmission line, most of the attenuation is caused by the cable.

In a case where an electromagnetic analysis simulation is conducted on a connector used for high-speed digital transmission as an object, the loss due to a mismatch of impedance and dielectric loss needs to be considered. Therefore, in the electromagnetic analysis simulation, such losses are calculated by an operation. Hereinafter, a calculation expression of the energy loss due to a mismatch of impedance, and a calculation expression for obtaining an acceptable impedance change value in a connection portion which is acceptable to the entirety of a transmission line from the amount of signal attenuation in the transmission line due to the dielectric loss are shown. The calculation expressions are employed by the electromagnetic analysis simulation.

### <Calculation of Energy Loss Due to Mismatch of Impedance>

Without performing waveform shaping using filtering, amplification, or the like and without performing multi-level signaling, a marginal bit rate at which transmission can be performed in a differential pair of metal transmission lines is about 10 Gbps. It is said that a higher transmission rate belongs to an optical communication region. Here, a general definition in a case of transmission at a bit rate of 10 Gbps will be described below.

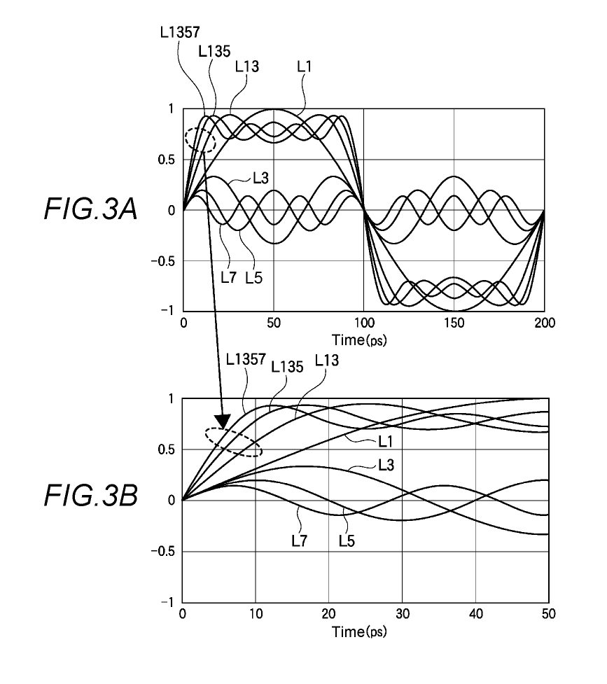

A fundamental wave at 10 Gbps has a frequency of 5 GHz, and a waveform obtained by overlapping odd harmonics such as a third harmonic or a fifth harmonic is referred to as a signal waveform at 10 Gbps. An image of signal waveforms is shown in FIG. 3A and FIG. 3B.

In FIG. 3A, the waveform of the fundamental wave is indicated by line L1, the waveform of the third harmonic is indicated by line L3, the waveform of the fifth harmonic is indicated line 15, and the waveform of a seventh harmonic is indicated by line 17. In addition, the waveform of the combination of the fundamental wave with the third harmonic is indicated by line L13, the waveform of the combination of the fundamental wave with the third harmonic and the fifth harmonic is indicated by line L135, and the waveform of the combination of the fundamental wave with the third harmonic, the fifth harmonic, and the seventh harmonic is indicated by line L1357. In addition, in FIG. 3A, the rise angles (portions surrounded by broken line) of the lines L13, L135, and L1357 are enlarged in a graph shown in FIG. 3B.

As illustrated in FIG. 3A and FIG. 3B, the number of combined odd harmonics (3, 5, and 7 multiples) is increased, and the inclination of the rise becomes steeper. That is, this means that the rise time of a rectangular wave signal specifies the band of harmonics included in the rectangular wave.

As illustrated in FIG. 3A and FIG. 3B, the fundamental wave has a frequency of 5 GHz, and the frequencies of the third harmonic, the fifth harmonic, and the seventh harmonic which are harmonic components of odd number multiples thereof respectively become 15 GHz, 25 GHz, and 35 GHz. From this, “a band necessary for the maximum odd harmonic in a case of specifying a rectangular wave” is obtained, and the rise time can be specified from the band. The following expressions include an expression for specifying the rise time in case of the third harmonic, an expression for specifying the rise time in a case of the fifth harmonic, and an expression for specifying the rise time in a case of the seventh harmonic.

$$Case of Third Harmonic \\ RiseTime = \frac{0.35}{15 GHz} = \frac{0.35}{15 \times {10}^{6}} 23.3 ps \\ Case of Fifth Harmonic \\ RiseTime = \frac{0.35}{25 GHz} = \frac{0.35}{25 \times {10}^{9}} = 14.0 ps \\ Case of Seventh Harmonic \\ RiseTime = \frac{0.35}{35 GHz} = \frac{0.35}{35 \times {10}^{9}} = 10.0 ps \qquad [ Expression 1 ]$$

That is, depending on the rise time of a necessary signal, a necessary band varies. That whether to consider up to the third harmonic, to consider up to the fifth harmonic, or to consider up to seventh harmonic is determined.

Naturally, when a transmission rate is increased, the length of 1 bit is reduced. When a bit length is reduced, a time allowed for rise is reduced, and as result, a steeper rise time is required. In order to realize a steep rise time, the order of odd harmonics to be considered is also increased.

In addition, as a frequency increases, attenuation in a transmission line increases. As described above, a high-frequency signal is formed by a composite wave of the first harmonic that is the fundamental wave and an odd number harmonic. However, as can be seen from FIG. 3A and FIG. 3B, the amplitude of the third harmonic or the fifth harmonic is drastically reduced compared to the fundamental wave. That is, this means that the fundamental wave is attenuated, the composite wave itself is reduced, and as a result, the third harmonic and the fifth harmonic are attenuated. As described above, it is seen that the amplitude level (attenuation amount) of the fundamental wave is significantly associated with the shape of a signal.

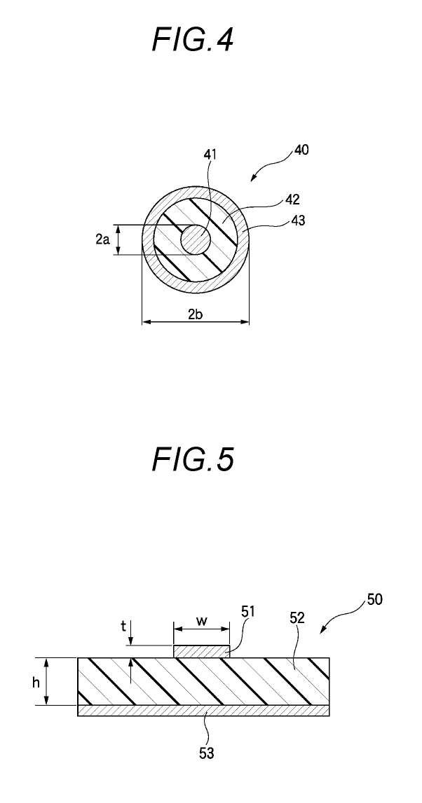

“Attenuation of Signal” will be described in the following expressions with reference to a coaxial cable 40 illustrated in FIG. 4. In FIG. 4, the coaxial cable 40 includes an inner conductor 41, an insulator 42 which covers the outer periphery of the inner conductor 41, and an outer conductor 43 which covers the outer periphery of the insulator 42.

$$Conductor Loss ( copper ) \\ {α}_{d} = \frac{9.5 \times {10}^{- 5} \times \sqrt{f} \times \sqrt{{ɛ}_{r}} \times ( a + b )}{a \times b \times ln ( \frac{b}{a} )} ( dB \text{/} UnitLength ) \\ Dielectric Loss \\ {α}_{c} = 27.3 \times \sqrt{{ɛ}_{r}} \times \frac{tan δ}{{λ}_{0}} ( dB \text{/} UnitLength ) \\ f \text{:} frequency ( GHz ) \\ tan δ \text{:} dielectric loss tangent \\ {ɛ}_{i} \text{:} permittivity \\ a \text{:} inner conductor radius \\ b \text{:} outer conductor radius \\ λ \text{:} wavelength \qquad [ Expression 2 ]$$

The sum of “conductor loss” and “dielectric loss” in the above expressions becomes the amount of signal attenuation in an ideal transmission line (a completely impedance-matched transmission line). By substituting 5 GHz which is the frequency of the fundamental wave, and the relative permittivity and dielectric loss tangent of the insulator 42 of the coaxial cable 40 into the above expressions, the amount of voltage loss per unit length can be calculated.

For example, since the insulator of a general coaxial cable uses polytetrafluoroethylene (PTFE) which is a fluororesin, the relative permittivity thereof is about 2.0, and the dielectric loss tangent thereof is about 0.0002 . In addition, when a radius a of the inner conductor 41 and a radius b of the outer conductor 43 of the coaxial cable 40 are determined from the relationship between the thickness of the inner conductor 41 specified in American wire gauge (AWG), the characteristic impedance of the coaxial cable 40, and the conductor loss of the inner conductor 41, a total loss amount is obtained as follows.

$$Inverse of outer conductor dimesions from impedance of coaxial cable \\ {Z}_{0} = \frac{60}{\sqrt{{ɛ}_{r}}} ln ( \frac{b}{a} ) ( Ω ) \\ 50 ( Ω ) = \frac{60}{\sqrt{2}} ln ( \frac{b}{0.459 + 2} ) \\ b = 0.75 mm \\ a = 0.2295 mm \\ Calculation of conductor loss from dimensions of coaxial cable \begin{matrix} {α}_{c} = \frac{9.5 \times {10}^{- 5} \times \sqrt{f} \times \sqrt{{ɛ}_{r}} \times ( a + b )}{a \times b \times ln ( \frac{b}{a} )} ( dB \text{/} UnitLength ) \\ = \frac{9.5 \times {10}^{- 5} \times \sqrt{5} \times \sqrt{2} \times ( 0.2295 + 0.750 )}{0.2295 \times 0.75 \times ln ( \frac{0.75}{0.2295} )} \times {10}^{3} ( dB \text{/} m ) \\ = 1.4437 ( dB \text{/} m )\end{matrix} Dielectric loss \begin{matrix}{α}_{d} = 27.3 \sqrt{{ɛ}_{r}} \frac{tan δ}{{λ}_{0}} ( dB \text{/} UnitLength ) \\ = 27.3 \times \sqrt{2} \times \frac{0.0002}{3 \times {10}^{10} + 5 \times {10}^{9}} \times {10}^{2} ( dB \text{/} m ) \\ = 0.1287 ( dB / m )\end{matrix} \\ Total loss Loss = {α}_{c} + {α}_{d} = 1.4437 + 0.1287 \approx 1.5724 ( dB \text{/} m ) \qquad [ Expression 3 ]$$

From the results, in a case where transmission in a 5 m long cable with a conductor diameter of No. 26 AWG wire in which PTEF is used as the insulator of the transmission line is postulated, the loss becomes five times 1.5724 [dB/m], and an attenuation of 7.862 [dB] occurs in the fundamental wave.

This calculation is performed on the frequency of a necessary odd harmonic, the loss in 15 GHz of of the third harmonic becomes 2.8866 [dB/m], the loss in 25 GHz of the fifth harmonic becomes 3.8716 [dB/m], and the loss in 35 GHz of the seventh harmonic becomes 4.7205 [dB/m]. Furthermore, in a case where transmission over 5 m is postulated, the third harmonic is attenuated by 14.433 [dB], the fifth harmonic is attenuated by 19.358 [dB], and the seventh harmonic is attenuated by 23.603 [dB].

In consideration of the attenuation amount of each of the odd harmonics, the fifth harmonic and the seventh harmonic are attenuated by about 20 [dB]. Since the amplitude is reduced to 1/100 in the attenuation, it can be said that the fifth harmonic or the seventh harmonic may not be considered in a case where a 5 m long transmission line is postulated. Contrary to this, the fundamental wave and the third harmonic are attenuated by 15 [dB] or less. When such an attenuation amount is achieved, in a case where the conductor is increased in thickness compared to No. 26 AWG wire which is postulated herein or the dielectric characteristics are enhanced compared to FIFE, transmission with a smaller attenuation amount can be achieved.

Therefore, it can be said that as the harmonics forming a rectangular wave for transmission at a rate of 10 Gbps, 5 GHz (first harmonic) which is the fundamental wave and up to the third harmonic having a frequency of 15 GHz may be considered.

### <Calculation of Acceptable Impedance Change Value in Electromagnetic Analysis Simulation>

It is preferable that impedance in a transmission line is constant. However, in an actual transmission line, a signal is transmitted from a transmission side to a reception side through various transmission lines such as a connection portion of a cable or a connector, printed wiring on an electronic board, or the like. In addition, a portion in which the shape or type of such transmission line changed necessarily accompanies discontinuous impedance. The coaxial cable illustrated in FIG. 4 and a microstrip line (MSL) are different from each other in the planned impedance dimensions as well as three-dimensional shapes, and thus is difficult to strictly maintain the impedance in a portion in which the type of the transmission line is changed in a constant level. Hereinafter, an impedance calculation expression of the coaxial cable and an impedance calculation expression of the microstrip line will be described.

### [Impedance Calculation Expression of Coaxial Cable]

$${Z}_{0} = \frac{60}{\sqrt{{ɛ}_{r}}} ln ( \frac{b}{a} ) ( Ω ) \\ {η}_{0} = \sqrt{\frac{{μ}_{0}}{{ɛ}_{0}}} , {μ}_{0} = 4 \cdot π \cdot {10}^{- 7} , {ɛ}_{0} = 8.85419 \cdot {10}^{- 12} \qquad [ Expression 4 ]$$

The impedance calculation expression of the coaxial cable uses the same concept as the coaxial cable used in the above description regarding loss. When the same dimensions and the permittivity (a=0.459 mm, b=1.5 mm, εr=2.0) are substituted, the coaxial cable of No. 26 AWG wire has a characteristic impedance of 50.24 [Ω].

### [Impedance Calculation Expression of Microstrip Line]

$${Z}_{0} = \frac{{η}_{0}}{2 \cdot \sqrt{2} \cdot π \cdot \sqrt{{ɛ}_{r} + 1}} ln \{ 1 + \frac{4 h}{{w}^{′}} [ \frac{14 + 8 \text{/} {ɛ}_{r}}{11} \cdot \frac{4 h}{{w}^{′}} + \sqrt{{( \frac{14 + 8 \text{/} {ɛ}_{r}}{11} )}^{2} \cdot {( \frac{4 h}{{w}^{′}} )}^{2} + \frac{1 + 1 \text{/} {ɛ}_{r}}{2} \cdot {π}^{2}} ] \} ( Ω ) \\ {η}_{0} = \sqrt{\frac{{μ}_{0}}{{ɛ}_{0}}} , {μ}_{0} = 4 \cdot π \cdot {10}^{- 7} , {ɛ}_{0} = 8.85419 \cdot {10}^{- 12} \\ {w}^{′} = w + Δ {w}^{′} , Δ {w}^{′} = Δ w ( \frac{1 + 1 \text{/} {ɛ}_{r}}{2} ) , \\ Δ w = \frac{t}{π} ln [ \frac{4 e}{{( \frac{t}{h} )}^{2} + {( \frac{1 \text{/} π}{w \text{/} t + 1.1} )}^{2}} ] \\ e = 2.718281828 \qquad [ Expression 5 ]$$

In the impedance calculation expression of the microstrip line, as illustrated in FIG. 5, the dimensions of the most simple printed board wire transmission line are calculated on the basis of the following conditions. In a microstrip line 50 of FIG. 5, a signal line 51 is provided on the upper surface of an insulator 52, and a GND 53 is provided at the lower surface thereof.

### <<Calculation Conditions>>

1) A characteristic impedance of 50 [Ω] is aimed for.

2) The diameter (0.459 mm) of the inner conductor 41 of the coaxial cable 40 and the width of the signal line 51 of the microstrip line 50 are approximated.

3) The relative permittivity of the insulator 52 is set to εr=4.5 of FR4 which is a general printed board material.

Under these conditions, 0.275 mm is obtained as the thickness (h) of the insulator 52 with which a characteristic impedance of 50 [Ω] is approximated. The characteristic impedance at this time is 50.2 [Ω], which is substantially the same as the characteristic impedance of the coaxial cable 40.

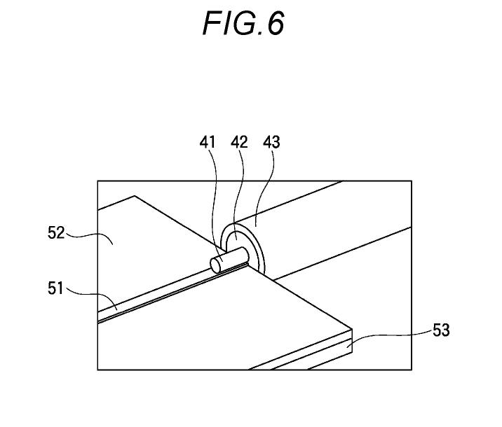

The microstrip line 50 (see FIG. 5) which is modeled on the dimensions and material characteristics (relative permittivity) obtained here is connected to the coaxial cable 40 (see FIG. 4), and the characteristic impedance in a case where the shape of the transmission line is changed is checked by time domain reflectometry (TDR) analysis. The results will be described, with reference to FIG. 6 to FIG. 8B.

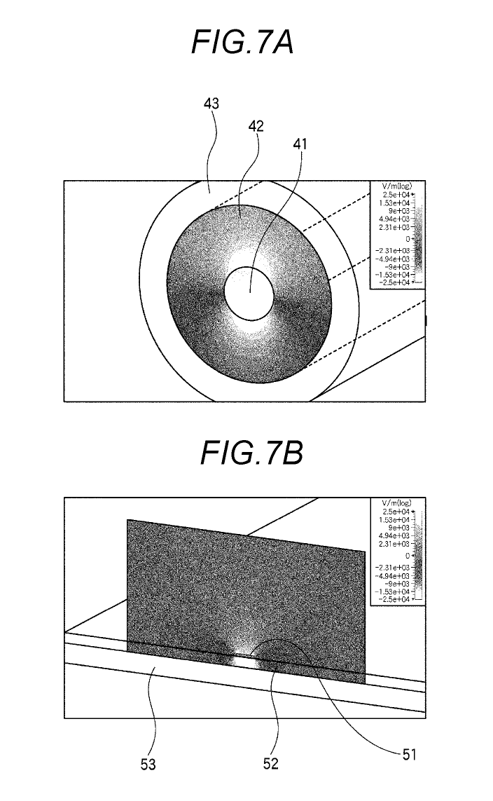

FIG. 6 is a perspective view illustrating a state in which the coaxial cable and the microstrip line are connected to each other. The coaxial cable and the microstrip line illustrated in FIG. 6 are transmission lines which have substantially the same characteristic impedance and have completely different shapes. In the transmission lines, the characteristic impedance value at each port is obtained as follows. That is, in a cross-section of the coaxial cable in the vicinity of the exposed inner conductor 41, as illustrated in FIG. 7A, the characteristic impedance value becomes 50.27 [Ω]. On the other hand, in a cross-section of the microstrip line in the vicinity of the exposed inner conductor 41, as illustrated in FIG. 7B, the characteristic impedance value becomes 50.57 [Ω]. These have slight differences from the values calculated in the above calculation expressions.

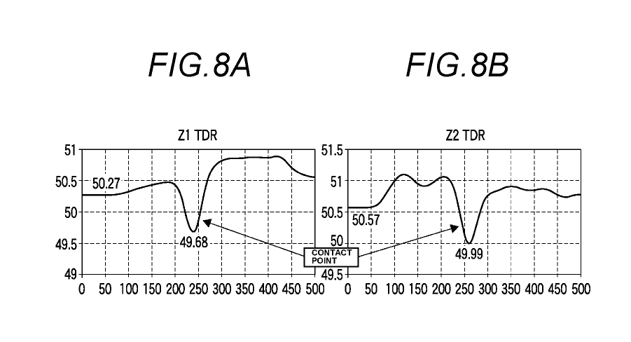

In addition, FIG. 8A and FIG. 8B illustrate TDR waveforms showing the impedance characteristics at a connection point in a case where the coaxial cable and the microstrip line having substantially the same characteristic impedance are connected to each other. As illustrated in FIG. 8A, in a case where the characteristic impedance of the transmission line is connected from 50.27 [Ω] on the coaxial side to 50.57 [Ω] on the MSL side, the characteristic impedance is not increased by 0.3 [Ω] at the connection point, but is decreased to 49.68 [Ω] by about 0.6 [Ω] and is then increased to approximately 50.8 [Ω], which is higher than the impedance of the MSL transmission line. Similarly, as illustrated in FIG. 8B, in case where the characteristic impedance or the transmission line is connected from 50.57 [Ω] on the MSL side to 50.27 [Ω] on the coaxial side, the characteristic impedance is not decreased by 0.3 [Ω] from 50.57 [Ω] on the MSL side to 50.27 [Ω] on the coaxial side, but is decreased to 49.99 [Ω] by about 0.6 [Ω] at the connection point and is then increased to 50.85 [Ω], which is higher than 50.27 [Ω]. As described above, in the case where the transmission lines having different shapes are connected to each other, it can be said that, since the physical shapes that design the characteristic impedances of the transmission lines affect each other at the connection portion, the impedance matching is collapsed.

Subsequently, the effect of a change in characteristic impedance described hereinabove on a signal that is propagated through a transmission line is considered. In the above-described example, an impedance change of 1.1 [Ω] is shown at the connection portion on the MSL side, and an impedance change of about 0.8 [Ω] is shown on the coaxial side. The impedance change can be substituted into a reflection coefficient(reflection loss) in the following expressions.

$$Reflection Coefficient \text{:} \vert Γ \vert = \frac{Z - {Z}_{0}}{Z + {Z}_{0}} , \\ Voltage Reflection Loss \text{:} - 10 log ( \frac{1}{\vert Γ \vert} ) [ dB ] \\ {Z}_{0} \text{:} characteristic impedance in each transmission line \\ Z \text{:} minimum impedance at change points . \qquad [ Expression 6 ]$$

When the characteristic impedance of each TDR waveform before and after the connection point (each transmission line) and the minimum impedance at the connection point are input to the above calculation expressions and calculations are performed, the maximum reflection coefficient [symbol] becomes 0.012, and the minimum reflection coefficient becomes 0.008. From the reflection coefficients, the voltage reflection loss of the input signal is obtained as 19.21 [dB] at the maximum and 20.97 [dB] at the minimum. As a ratio, a voltage of about 1/100 is reflected and is thus not transmitted.

This is a very small loss only in terms of numerical value. However, it is described that even when transmission lines having almost the same characteristic impedance are connected to each other, a signal is not transmitted at 100% and reflections are accompanied anyhow. For example, when HDMI® which is a high-speed digital signal transmission standard is exemplified, in a case where the characteristic impedance of the transmission line is 100 [Ω] and an impedance change in the transmission line is ±25 [Ω] (125 [Ω] or 75 [Ω]), a reflection coefficient [symbol] from 125 [Ω] is 0.11 and a reflection loss is about 9.59 [dB], and a reflection coefficient [symbol] from 75 [D] is 0.14 and a reflection loss is 8.54 [dB], such that power of about 1/10 not transmitted but is lost.

Since an impedance discontinuous point occurs at each change point of the transmission line shape, all reflections at several to tens of change points that are present in the transmission lines, such as connectors mounted from a board, male and female connector fitting terminal portions, a connection portion of a connector and a cable, and the like have to be considered. Furthermore, as also described above in “Items Analyzed by Electromagnetic Analysis Simulation”, losses due to the insulator are also included. Therefore, it is easily seen that an impedance change at each place has to be suppressed as much as possible.

### <Electromagnetic Analysis Simulation Model>

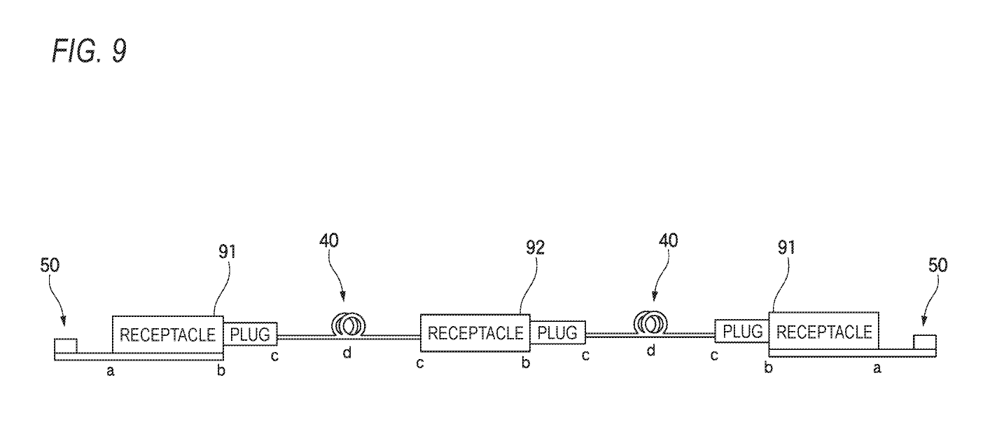

FIG. 9 illustrates a transmission line which is modeled to conduct an electromagnetic analysis simulation. In FIG. 9, the two microstrip lines 50 are respectively connected to the coaxial cables 40 via board connection connectors 91, and the two coaxial cables 40 are connected to each other via a relay connector 92. In addition, a point a of FIG. 9 represents a connection point of the signal line 51 of the microstrip line 50 and the board side terminal of the board connection connector 91, a point b represents a connection point of the board side terminal of the board connection connector 91 and the cable side terminal of the board connection connector 91, a point c represents a connection point of the cable side terminal of the board connection connector 91 and the inner conductor 41 of the coaxial cable, and a point d represents an arbitrary point on the coaxial cable 40. In addition, details of the transmission line of FIG. 9 are as follows.

Connector connection portion: three points (two points for board connection and one point for relay)

Overall cable length: 5 m

Cable center conductor diameter: No. 26 AWG wire (insulator relative permittivity εr: 2, dielectric loss tangent. tan δ: 0.0002)

Cable type: shielded differential pair cable (SATA type double drain)

Total transmission loss: within ⅛ (voltage loss of 9.0309 dB) of the amplitude of the fundamental wave at the reception end

Transmission line impedance: 100 [Ω] (differential)

As described in the section of “the energy loss due to a mismatch of impedance”, when calculations are performed in a case where the εr of the PTFE in No. 26 AWG wire is 2 and the tan δ thereof is 0.0002, the loss of the single cable (d) about 1.5724 [dB/m], and an attenuation of 7.8620 [dB] occurs in a 5 m long transmission line. 1.1689 [dB] obtained by subtracting the loss of 7.8620 [dB] of only the cable from the total transmission loss of 9.0309 [dB] becomes the acceptable loss amount in the connector portion (a×2+b×3+c×4).

Among the three types of connection points of the points a, b, and c, the points a and c are connection points of the board connection connector 91 and the coaxial cable 40 or the microstrip line 50 and are different from the fitting points of the connector to which the terminal connection structure of the present invention is applied. Here, regarding each of the points a and c, connection with ideal impedance is postulated, and it is assumed that the maximum change impedance amount of 1.1 [Ω], which is handled above in the section of the reflection loss, is present at each point.

The number of the points a is two, and the number of points c is four. Therefore, the number of the sum of the points a and c is 6, and when it is assumed that two reflections are present due to an increase and a decrease in impedance at each of the points and the reflections are converted into the amplitude (voltage) loss of a signal, the reflection loss at this time is obtained as follows.

$$Reflection Coefficient \text{:} \vert Γ \vert = \frac{Z - {Z}_{0}}{Z + {Z}_{0}} , \\ Voltage Reflection Loss \text{:} - 10 log ( \frac{1}{\vert Γ \vert} ) [ dB ] \\ {Z}_{0} \text{:} characteristic impedance in each transmission line \\ Z \text{:} minimum impedance at change points \\ \vert Γ \vert = \frac{98.9 - 100}{98.9 + 100} = 0.0055 , \\ \vert Γ \vert = \frac{101.1 - 100}{101.1 + 100} = 0.0055 \\ - 10 log ( \frac{1}{1 - 0.0055} ) = 0.0239 [ dB ] , \\ 0.0239 \times {6}_{points} \times {2}_{times} = 0.2868 [ dB ] \qquad [ Expression 7 ]$$

Therefore, 0.8821 [dB] which is obtained by subtracting 0.2868 [dB] from 1.1689 [dB] of the attenuation amount that is acceptable in the connector portion becomes the total attenuation acceptable value of the three points of the connector fitting portions of the points b, and 0.2940 [dB] which is ⅓ thereof becomes the connector fitting portion acceptable loss. When an inverse operation is performed to obtain the value Ω of acceptable impedance change from the acceptable attenuation amount of 0.2940 [dB] due to an impedance change in the connector fitting portion obtained herein, a single change is acceptable in an impedance range between 88 [Ω] to 114 [Ω] with a reflection coefficient [symbol] of 0.0655. In addition, in a case where a plurality of changes occur, determination may be performed based on an attenuation amount obtained by synthesizing a lower impedance change amount and the number of changes.

<Analysis Results and Discussion of Terminal Connection Structure having Tuning Fork Type Female Terminal of Related Art>

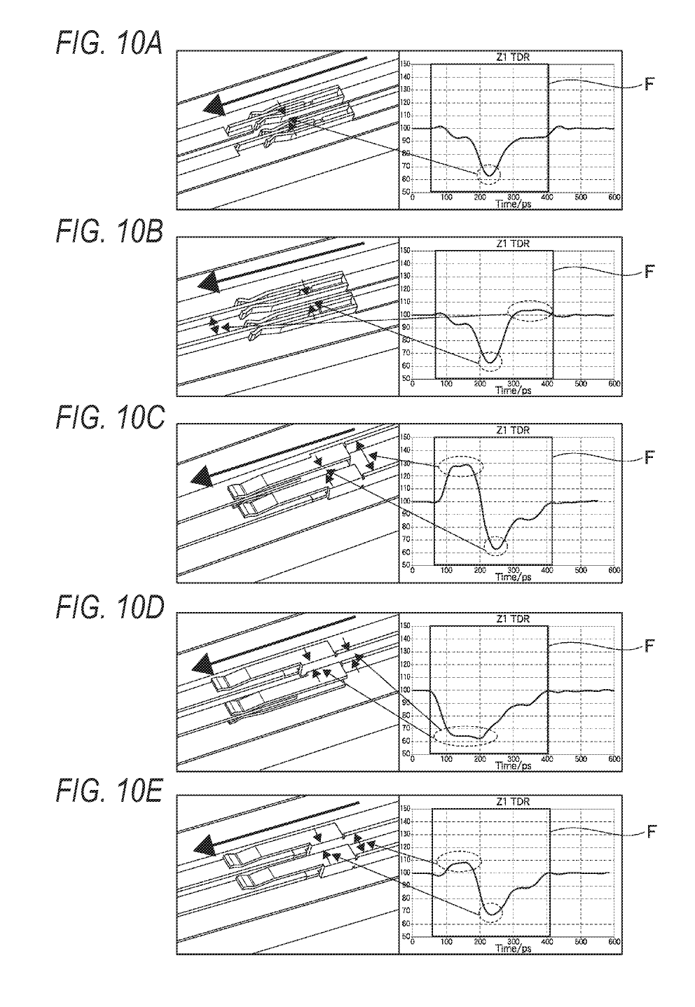

As described hereinbefore, when the shape of a transmission line is changed, the impedance is changed, reflections occur, and the transmission signal is lost. This is subjected to an electromagnetic analysis simulation using a model in which a two-edged terminal, which is a tuning fork type female terminal of the related art, is applied to the point b of “electromagnetic analysis simulation model” described, above FIG. 10A to FIG. 10E illustrate electromagnetic analysis simulation models and analysis results of the models. FIG. 10A to FIG. 10E show the analysis results of the electromagnetic analysis simulation performed by variously changing the arrangement and shapes of the two-edged terminals (female terminal) and one (male terminal) interposed therebetween.

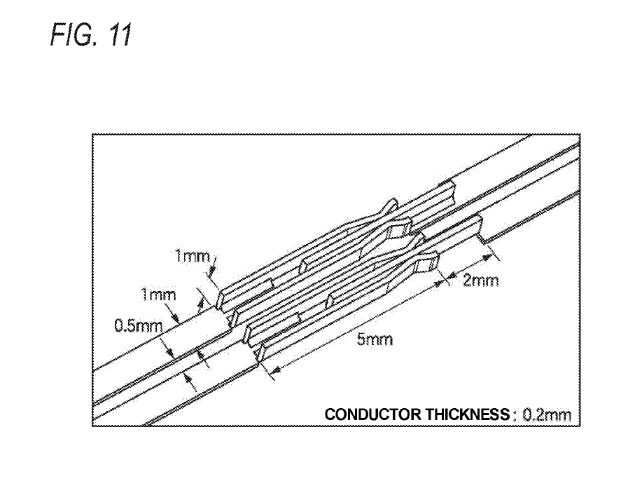

FIG. 11 shows the schematic dimensions of the terminals in the examples of FIG. 10A to 10E. The left and right sides in FIG. 11 act as ports that allow a high-frequency signal to oscillate, and were each set to a differential characteristic impedance of 100 [Ω]. The terminal interval, the surrounding insulator material characteristics, and the like were determined by using a method of designing a stripline. In addition, the structure of the stripline will be described, later with reference to FIG. 11.

FIG. 10A and FIG. 10B model a state in which a tab terminal portion that is vertically erected and extends with respect to a flat plate-shaped male terminal body is positioned between the two-edged terminals that are vertically erected and extend with respect to a flat plate-shaped female terminal body and comes into contact with the two-edged terminals. In FIG. 10B, the tab terminal portion and contact terminal portions are erected vertically (upper side in FIG. 10A). FIGS. 10A and 10B are different from each other in the intrusion depth of the tab terminal portion between the two-edged terminals. That is, FIG. 10A shows a narrow intrusion depth of the tab terminal portion between the two-edged terminals, and FIG. 10A shows a deep intrusion depth of the tab terminal portion between the two-edged terminals. In addition, in the models shown in FIGS. 10C and 10D, the flat plate-shaped male terminal body and the female terminal body in the model of FIG. 10B are rotated by 90 degrees and −90 degrees around their longitudinal directions. FIG. 10C models a state in which the male terminal and the female terminal are rotated so as to cause the male terminal body of the male terminal and the female terminal body of the female terminal to become distant from each other. In addition, FIG. 10D, models a state in which the male terminal and the female terminal are rotated so as to cause the male terminal body of the male terminal and the female terminal body of the female terminal to become close to each other. The model shown in FIG. 10F is a model in which the two flat plate-shaped male terminal body and the female terminal body in the model of FIG. 10B are rotated by 90 degrees in the same direction.

A frame F of the TDR graph shown on the right of each of FIG. 10A to FIG. 10E shows an observation region, and the outside (left and right) of the frame F shows a set impedance of a signal excitation port. TDR was calculated with a rise time of 35 ps. This is because the rise time is a rise time corresponding to “10 GHz” in the section of the calculation of a necessary band described above (in order to obtain sufficient analysis accuracy, a frequency band of a multiple of 5 GHz which is the fundamental wave at 10 Gbps was set).

In FIG. 10A, flat portions before and after a point where the tab terminal portion of the male terminal and the two-edged terminals of the female terminal come into contact with each other has an impedance of about 93 [Ω]. At the contact point, the thickness direction of the terminal is increased from 0.2 mm to 1 mm, the characteristic impedance is decreased to approximately 63 [Ω] by 30 [Ω].

In FIG. 10B, the impedance is decreased to 63 [Ω] by 30 [Ω] at the contact point from 93 [Ω] at the flat portions before and after the point where the tab terminal portion of the male terminal and the two-edged terminal of the female terminal come into contact with each other, and thereafter, the impedance is increased to 104 [Ω] since the two-edged terminals of the male terminal are erected (the distance between the two-edged terminals is open).

In FIG. 10C, the distance between the flat plate-shaped female terminal bodies of the female terminal is significantly open, and thus the impedance is increased to approximately 130 [Ω]. However, at the point where the tab terminal of the male terminal and the two-edged terminals of the female terminal come into contact with each other, the terminals abruptly approach each other, and thus the impedance is decreased to 63 [Ω] by about 70 [Ω] as in FIG. 10A or FIG. 10B.

In FIG. 10D, the distance between the flat plate-shaped female terminal bodies of the female terminal approximates the same distance and height (thickness) as those of the point where the tab terminal portion of the male terminal and the two-edged terminals of the female terminal come into contact with each other, and thus a transition region of 63 [Ω] is significantly lengthened.

In FIG. 10E, the dimensions show a shape in which the male terminal side and the female terminal side of FIG. 10B are inverted, and the TDR results also show inverted characteristics.

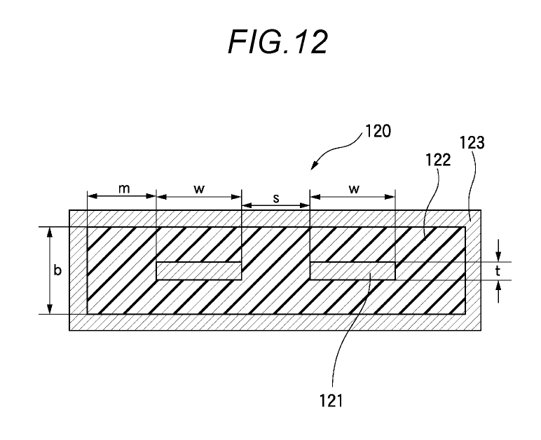

From the above results, it can be seen that the thickness (height) of the male terminal and the female terminal are changed, and the impedance is drastically reduced. In addition, it can be also seen that as the inter-terminal distance between the flat plate-shaped male terminal body and the female terminal body is increased, the impedance is drastically increased. Such a change in impedance is a phenomenon common to the stripline structure. A stripline is a transmission line in a medium interposed between upper and lower conductors and is generally defined by FIG. 12 and the following expression. A stripline 120 illustrated in FIG. 12 is constituted by two inner conductors 121, a dielectric material 122 that covers each of the inner conductors 121, and an outer conductor 123 that covers the dielectric material 122.

$${Z}_{diff} = 2 \times {Z}_{0 , o} , \\ {Z}_{0 , o} = \frac{120 π}{\sqrt{{ɛ}_{r}}} \cdot \frac{ɛ}{{C}_{0 , o}} \\ \frac{{C}_{0 , o}}{ɛ} = 2.0 \cdot ( \frac{{C}_{p}}{ɛ} + \frac{{C}_{fo}^{′}}{ɛ} + \frac{{C}_{fom}^{′}}{ɛ} ) \\ \frac{{C}_{p}}{ɛ} = \frac{2.0 \cdot w}{b - t} \\ \frac{{C}_{fo}^{′}}{ɛ} \approx \frac{2.0}{π} \cdot ln ( 1.0 + cont \frac{π \cdot s}{2.0 \cdot b} ) + \frac{t}{s} \cdot ( 1.0 - \frac{s}{2.0 \cdot b} ) \\ \frac{{C}_{fom}^{′}}{ɛ} \approx \frac{2.0}{π} \cdot ln [ 1.0 + cont \frac{π \cdot m}{2.0 \cdot b} + \frac{t}{m} \cdot ( 1.0 - \frac{m}{2.0 \cdot b} ) ] \\ t \text{:} inner conductor thickness \\ w \text{:} inner conductor width \\ s \text{:} inner conductor interval \\ b \text{:} dielectric material thickness \\ m \text{:} interval from wall surface \\ ɛ r \text{:} relative permittivity \\ ɛ o \text{:} permittivity under vacuum \\ ɛ \text{:} ɛ o \times ɛ r \qquad [ Expression 8 ]$$

From the expressions shown above, it can be seen that the total capacitive coupling C0,o of Cfo (capacitive coupling between differential signals), Cp (capacitive coupling between signal line and upper and lower GND), and Cfom (capacitive coupling between signal wall and wall surface) is in inverse proportion to impedance. That is, when the interval S between the inner conductors 121 is reduced or the thickness t of the inner conductors 121 is increased, the interline capacitive coupling is increased, resulting in a decrease in impedance. From this, it can be seen that a change in the thicknesses of the male terminal and the female terminal which are arranged at a predetermined distance interval in a connector causes change in characteristic impedance. In addition, it can be also seen that when the thicknesses of the male terminal and the female terminal are great, the impedance becomes more sensitive to the inter-line distance.

Separately from this, when the width w of the inner conductor 121 is changed, not the inter-line capacitance but the capacitance (Cp) between the upper and lower outer conductors 123 is changed. For example, when the width w of the inner conductor 121 is increased, Cp is increased. When the width w is decreased, Cp is also decreased. As a result, the width w of the inner conductor 121 is also in inverse proportion to impedance.

From this, it was seen that a structure in which the thickness, width, inter-line distance, and the like of the male terminal and the female terminal in a connector are not changed as much as possible in a contact point where the male terminal and the female terminal come into contact with each other is preferable for high-speed digital transmission at a rate of several Gbps.

### <Effects of Terminal Connection Structure of the Present Invention>

When the problem of the related art is re-examined on the basis of the description of the definition of the high-speed digital transmission and the behavior of impedance in the connector, a change in impedance cannot be avoided due to the shapes of the male terminal and the female terminal during fitting and the inter-terminal distance and shapes thereof before and after fitting. Therefore, it is thought that the related art is inappropriate for high-speed digital transmission at a rate of several Gbps.

Here, in the terminal connection structure of the present invention, by using the male terminal 12 and the female terminal 13 described with reference to FIG. 1 to FIG. 2B, it becomes possible to realize excellent electrical characteristics that are impossible in the terminal connection structure including the tuning fork type female terminal of the related art.

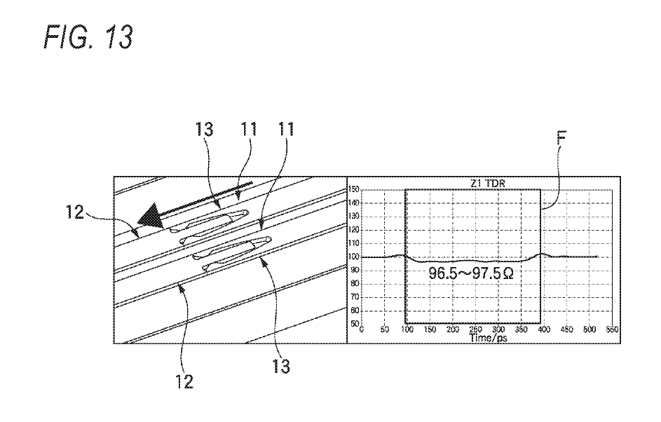

FIG. 13 shows verification results of transmission loss in the terminal connection structure of the present invention. In addition, a frame F of the TDR graph shown on the right of FIG. 13 shows an observation region, and the outside (left and right) of the frame F shows a set impedance of a signal excitation port. TDR was calculated with a rise time of 35 ps.

As described above, in a case where the tuning fork type female terminal of the related art is modeled, as shown in FIG. 10A, the characteristic impedance is decreased to approximately 63 [Ω] by 30 [Ω]. In addition, when the reflection loss at this characteristic impedance is calculated, a voltage reflection loss becomes 6.44 [dB], and by only this, a passage loss of 1.1182 [dB] is generated. That is, substantially the same loss as 1.1689 [dB], which is set as the acceptable loss amount in the entirety of the connector portion occurs due to terminal fitting at a single point. Therefore, it was found that it is difficult to use the related art for a high-speed digital transmission line in which a rate of 10 Gbps is postulated.

Contrary to this, according to the terminal connection structure of the present invention, as shown in FIG. 13, by allowing the male terminal 12 and the female terminal 13 to be fitted on the same plane and come into contact with each other, the characteristic impedance of in the connector becomes substantially constant, and ideal characteristics with substantially no reflections are obtained. An impedance chance width in the transmission line in the connector is vertically about 1 [Ω] with respect to 96.5 Ω, and thus the passage voltage loss becomes 0.022 [dB] with a voltage reflection loss of 33 [dB]. Therefore, it can be seen that a lower reflection loss amount than that in the results of ideal connection between a coaxial cable and an MSL is achieved.

That is, in the terminal connection structure 11 according to the present invention, the terminal shapes of the male terminal 12 and the female terminal 13 can be regarded as being the same as those of a differential stripline transmission line. In the terminal connection structure 11 according to the present invention, which can be treated as a differential stripline transmission line as described above, a change in physical shape at the point where the male terminal 12 and the female terminal 13 are fitted to each other is suppressed. As a result of a small shape change, the terminal connection structure 11 according to the present invention exhibits excellent electrical characteristics.

In addition, in the terminal connection structure having the tuning fork type female terminal of the related art, signal current is concentrated on the male terminal from the ends of the tuning fork type female terminal. On the other hand, in the present invention, a straight path of the signal current can be maintained, which contributes to the suppression of the deterioration of the electrical characteristics.

In addition, according to the terminal connection structure of the present invention, by fitting the male terminal 12 and the female terminal 13 to each other, the contact portions 33 formed in the contact terminal portions 32 of the female terminal 13 come into contact with the tab terminal portion 22 of the male terminal 12, and thus a good conduction state can be obtained.

In addition, by fitting the male terminal 12 and the female terminal 13 to each other, the contact terminal portions 32 of the female terminal 13 abut the engagement protrusions 23 of the male terminal 12. Accordingly, a shape advantageous to the characteristics or a high-frequency wave that flows through the surface or edge of a transmission line is achieved.

Particularly, the tip end portions of the contact terminal portions 32 of the female terminal 13 abut the engagement protrusions 23 of the male terminal body 21 of the male terminal 12, and the contact terminal portions 32 of the female terminal 13 are pressed against the center side of the male terminal 12 by the guide surface portions 24. Accordingly, the contact portions 33 of the contact terminal portions 32 are pressed against and come into close contact with the side surfaces of the tab terminal portion 22, and thus conduction is reliably achieved.

The present invention is not limited to the above-described embodiments, and appropriate modifications, improvements, and the like can be made. In addition, the materials, shapes, dimensions, numbers, arrangement points, and the like of the constituent elements in the above-described embodiments are arbitrary and are not limited as long as the present invention can be accomplished.

Here, the features of the embodiments of the terminal connection structure according to the present invention described above are concisely listed in the following [1] to [4].

[1] A terminal connection structure (11), wherein the terminal connection structure (11) connects a male terminal (12) to a female terminal (13),

wherein the male terminal (12) comprises:

a male terminal body (21) which is formed in a flat plate shape; and

a tab terminal portion (22) which extends from a tip end of the male terminal body (21) toward a direction of connection to the female terminal (13) on the same plane as the male terminal body (21),

wherein the female terminal (13) comprises:

a female terminal body (31) which is formed in a flat plate shape; and

a pair of contact terminal portions (32) which extends from a tip end of the female terminal body (31) toward a direction of connection to the male terminal (12) on the same plane as the female terminal body (31), and

wherein the tab terminal portion (22) of the male terminal (12) is positioned between the pair of contact terminal portions (32) of the female terminal (13) on the same plane as the plane on which the contact terminal portions (32) extend, and the tab terminal portion (22) abuts the pair of contact terminal portions (32), and

wherein widths of the male terminal (12) and the female terminal (13) are even in a contact point where the male terminal and the female terminal are contact with each other.

[2] The terminal connection structure (11) described in [1],

wherein widths of the male terminal (12) and the female terminal (13) are even in a contact point where the male terminal and the female terminal are contact with each other.

[3] The terminal connection structure (11) described in [1],

wherein contact portions (33) which protrude in directions to face each other are formed in the contact terminal portions (32).

[4] The terminal connection structure (11) described in any one of from [1] to [3],

wherein engagement protrusions (23) which abut the contact terminal portions (32) are formed in the male terminal body (21).

[5] The terminal connection structure (11) described in [4] or [5],

wherein the engagement protrusions (23) comprises:

guide surface portions (24) which displace tip end portions of the contact terminal portions (32) toward the tab terminal portion (22) side.

While the present invention has been described in detail with reference to the specific embodiments, it should be noted by those skilled in the art that various changes and modifications can be added without departing from the spirit and scope of the present invention.

This application is based on a Japanese patent application (Japanese Patent Application No. 2013-150886) filed on Jul. 19, 2013, the content of which is incorporated herein by reference.

### INDUSTRIAL APPLICABILITY

The terminal connection structure of the present invention can cope with high-speed digital transmission and can obtain good electrical characteristics. The present invention that exhibits the effects is useful in the field of terminals.

### REFERENCE SIGNS LIST

11 terminal connection structure

12 male terminal

13 female terminal

21 male terminal body

22 tab terminal portion

23 engagement protrusion

24 guide surface portion

31 female terminal body

32 contact terminal portion

33 contact portion

40 coaxial cable

41 inner conductor

42 insulator

43 outer conductor

50 microstrip line

51 signal line

52 insulator

53 GND

What is claimed is:

1. A terminal connection structure,
wherein the terminal connection structure connects a male terminal to a female terminal,
wherein the male terminal comprises:
a male terminal body which is formed in a flat plate shape; and
a tab terminal portion which extends from a tip end of the male terminal body toward a direction of connection to the female terminal on the same plane as the male terminal body,
wherein the female terminal comprises:
a female terminal body which is formed in a flat plate shape; and
a pair of contact terminal portions which extends from a tip end of the female terminal body toward a direction of connection to the male terminal on the same plane as the female terminal body, and
wherein the tab terminal portion of the male terminal is positioned between the pair of contact terminal portions of the female terminal on the same plane as the plane on which the contact terminal portions extend, and the tab terminal portion abuts the pair of contact terminal portions,
wherein widths of the male terminal and the female terminal are approximately even in a contact point where the male terminal and the female terminal are contact with each other.

2. The terminal connection structure according to claim 1,
wherein thins of the male terminal and the female terminal are approximately even in the contact point where the male terminal and the female terminal are contact with each other.

3. The terminal connection structure according to claim 1,
wherein contact portions which protrude in directions to face each other are formed in the contact terminal portions.

4. The terminal connection structure according to claim 1,
wherein engagement protrusions which abut the contact terminal portions are formed in the male terminal body.

5. The terminal connection structure according to claim 2,
wherein engagement protrusions which abut the contact terminal portions are formed in the male terminal body.

6. The terminal connection structure according to claim 3,
wherein engagement protrusions which abut the contact terminal portions are formed in the male terminal body.

7. The terminal connection structure according to claim 4,
wherein the engagement protrusions comprises:
guide surface portions which displace tip end portions of the contact terminal portions toward the tab terminal portion side.

8. The terminal connection structure according to claim 5,
wherein the engagement protrusions comprises:
guide surface portions which displace tip end portions of the contact terminal portions toward the tab terminal portion side.
